(19) United States
(12) Patent Application Publication
(10) Pub. No.: US 2004/0159557 A1
(43) Pub. Date: Aug. 19, 2004

(54) Electrolytic polishing liquid, electrolytic polishing method and method for fabricating semiconductor device

(76) Inventors: Shuzo Sato, Kanagawa (JP); Takeshi Nogami, Kanagawa (JP); Shingo Takahashi, Kanagawa (JP); Naoki Komai, Kanagawa (JP); Kaori Tai, Kanagawa (JP); Hiroshi Horikoshi, Kanagawa (JP); Hiizu Ohtorii, Kanagawa (JP)

Correspondence Address: Lewis T Steadman Sr & Robert J Depke, Holland & Knight, Suite 800, 55 West Monroe Street, Chicago, IL, 60603, US

(21) Appl. No.: 10/481,995

(22) PCT Filed: Apr. 25, 2003
(86) PCT No.: PCT/JP03/05366

(30) Foreign Application Priority Data
Apr. 3, 2002 (JP) 2002-129163

(51) Int. Cl. B23H 3/00

(52) U.S. Cl. 205/682

(57) ABSTRACT

Electric conductivity is enhanced without causing coagulation or precipitation of polishing abrasive grains. In addition, good planarization is realized without inducing defects in a metallic film or a wiring which are to be polished.

In an electropolishing method for planarizing the surface of a metallic film to be polished by moving a polishing pad (15) in sliding contact with the metallic film surface while oxidizing the metallic film surface through an electrolytic action in an electropolishing liquid E, the electropolishing liquid E contains at least polishing abrasive grains and an electrolyte for maintaining an electrostatically charged state of the polishing abrasive grains. Since the electropolishing liquid having a high electric conductivity is used, it is possible to obtain a high electrolyzing current and to enlarge the distance between electrodes. Besides, in the electropolishing method, the electropolishing liquid with a good dispersion state of the polishing abrasive grains is used, so that remaining of the abrasive grains and defects such as scratches are prevented from being generated upon polishing.

### TECHNICAL FIELD

The present invention relates to an electropolishing liquid containing at least abrasive grains. In addition, the present invention relates to an electropolishing method using the electropolishing liquid, and a method of fabricating a semiconductor device.

### BACKGROUND ART

Conventionally, aluminum (Al) based alloys have been used as a material for fine wiring in a semiconductor device such as an LSI (Large Scale Integration) formed on a semiconductor wafer. However, since the circuit delay due to parasitic resistances and parasitic capacities in the wiring becomes dominant as the wiring becomes more and more finer, adoption of copper (Cu) being lower in resistance and capacity than Al based alloys and promising a high reliability as the wiring material has been investigated. Copper is expected as a next-generation material because it has a low resistivity of 1.8 μΩcm, which is advantageous for enhancing the speed of the LSI, and its electromigration resistance is higher than those of Al based alloys by about one order.

In forming a wiring by use of Cu, the so-called Damascene process is used, since it is generally difficult to perform dry etching of Cu. The Damascene process is a method of forming a wiring by, for example, preliminarily forming predetermined grooves in an inter-layer insulating film consisting of silicon oxide, then filling up the grooves with Cu used as the wiring material, and then removing the surplus wiring material by chemical mechanical polishing (hereinafter referred to as CMP). Furthermore, there is also known the dual Damascene process in which connection holes (vias) and wiring grooves (trenches) are formed, filling up with the wiring material is performed collectively, and then the surplus wiring material is removed by CMP.

Besides, in order to meet the future demand for LSIs having higher speed and lower power consumption and to suppress the RC delay of the wiring, adoption of an extremely low dielectric constant, for example, porous silica having a dielectric constant of 2 or below, as the material for the inter-layer insulating film has been investigated, in addition to the above-mentioned Cu wiring technology.

However, these low dielectric constant materials are all extremely brittle; therefore, under a processing pressure of 4 to 6 PSI (i.e., 280 to 420 g/cm², since 1 PSI is about 70 g/cm²) which is exerted at the time of carrying out the conventional CMP, the insulating film formed of the low dielectric constant material undergoes collapse, cracking, exfoliation or the like, making it impossible to form a satisfactory wiring. On the other hand, when the CMP pressure is lowered to about 1.5 PSI (105 g/cm²), which is an endurable pressure for the insulating film formed of the low dielectric constant material, in order to prevent the collapse and the like, it is impossible to obtain a polishing rate necessary for an ordinary production speed. Thus, there is a fundamental problem in carrying out the CMP in the formation of a wiring by use of an extremely low dielectric constant material.

Accordingly, in order to solve the above-mentioned problems in the CMP, trials for polishing the surplus Cu by electropolishing through reverse electrolysis to form a Damascene structure or a dual Damascene structure have been being conducted

However, simple reverse electrolysis of plating causes conformal and uniform dissolution and removal of the surplus Cu from a surface layer, and, therefore, is a technique poor in planarizing capability. Particularly, where the trenches and vias are filled up with Cu by electroplating according to the ordinary Damascene process or dual Damascene process, it is impossible with the simple reverse electrolysis of plating to perfectly planarize the ruggedness formed in the surface upon electroplating. The reason is as follows. A variety of additives added to the electroplating liquid for the purpose of achieving perfect filling-up without causing such defects as voids and pits at the time of Cu electroplating cause the generation of raised portions (humps) exceeding a predetermined value in a fine wiring concentration area, dishing in a large wiring width area, or the like, so that giant projections and recesses are left in the surface. As a result, upon completion of polishing, there arise the problems such as over-polishing, e.g., partial disappearance of wiring, dishing, recesses, etc., and under-polishing, e.g., short-circuit between wirings, formation of islands, etc.

In view of the above, there has been proposed a polishing method in which the electropolishing by reverse electrolysis as above-mentioned and wiping by use of a pad are performed simultaneously, whereby a polishing rate necessary for an ordinary production speed can be obtained with a low pressure.

In this method, an electric current is passed by using as an anode the metallic film (e.g., Cu film) on the semiconductor wafer surface which constitutes the object to be polished, and an electrolyzing current is passed by impressing an electrolyzing voltage between the anode and a counter electrode constituting a cathode which is disposed opposite to the semiconductor wafer, to thereby perform electropolishing. The electropolishing causes anodic oxidation of the surface of the metallic film which undergoes the electrolytic action as the anode, with the result that an oxide film is formed as a surface layer. Further, the oxide thus formed reacts with a complexing agent contained in the electrolytic liquid, whereby a denatured layer such as a high electric resistance layer, an insoluble complex film, a passivation film, etc. is formed at the surface of the metallic film, Simultaneously with the electropolishing, the denatured layer is removed by wiping it with a pad. In this case, of the metallic film having recessed portions and projected portions, only the denatured layer at the surface layer of the projected portions is removed to expose the base metal, whereas the denatured layer at the surface layer of the recessed portions is left. Therefore, only the projected portions where the base metal is exposed are partially re-electrolyzed, and the further wiping causes a progress of polishing of the projected portions. Such a cycle is repeated, whereby the surface of the semiconductor wafer is planarized.

In this technology, for enhancing the planarizing capability, use is made of an electropolishing liquid which is prepared by adding an electrolyte to a base constituted of a CMP slurry containing abrasive grains, e.g., alumina abrasive grains, so as to secure electric conductivity necessary for passing the electrolyzing current.

Meanwhile, when the alumina abrasive grains in the electropolishing liquid are coagulated, fatal defects such as scratches are liable to be generated in the polished surface. Therefore, it is necessary for the abrasive grains to be completely dispersed in the electropolishing liquid at the time of electropolishing. Accordingly, the pH of the electropolishing liquid is maintained on the acidic side, whereby the alumina abrasive grains are electrostatically charged in plus polarity so that they repel each other due to their zeta potential, thereby realizing a good dispersion state.

However, depending on the electrolyte added, the pH of the electropolishing liquid may be neutral or on the basic side, which leads to a reduction of the zeta potential of the alumina abrasive grains and, hence, to coagulation or precipitation of the alumina abrasive grains. As a result, giant defects such as generation of scratches and remaining of the alumina abrasive grains would occur upon polishing, to thereby give rise to short-circuit between wirings, formation of open-circuit, or the like.

In addition, depending on the electrolyte used for imparting electric conductivity to the electropolishing liquid, there may arise corrosion-induced roughening of the Cu film surface at the end point of polishing, formation of pits due to concentration of current, and the like, which make it difficult to form a good end-point surface. Namely, simple addition of an electrolyte would lead to the formation of a surface which has a high surface roughness and a unstable wiring electric resistance.

Furthermore, the electropolishing liquid has an etching action Therefore, in the case where the ratio of the area of the metallic film based on the whole surface of the semiconductor wafer is reduced from the state of 100% in the initial stage of polishing where the metallic film is formed on the whole surface of the wafer to the state where only the wiring patterns are left upon completion of the removal of the surplus portions, the concentration of the dissolution rate on fine wiring portions may increase the difference in removal rate between the giant left portions or large wiring width portions and the independent fine wiring portions, thereby leading to an accelerated rise in the dissolution rate of the fine wirings and, hence, to disappearance of the wiring.

The present invention has been proposed in consideration of the above-mentioned circumstances. Accordingly, it is an object of the present invention to provide an electropolishing liquid with which it is possible to enhance electric conductivity without generating coagulation or precipitation of polishing abrasive grains. In addition, it is another object of the present invention to provide an electropolishing method, and a method for fabricating a semiconductor device, with which it is possible to realize good planarization without inducing defects in a metallic film or wirings which are bodies to be polished.

### DISCLOSURE OF INVENTION

In order to attain the above objects, according to the present invention, there is provided an electropolishing liquid for use in an electropolishing method for planarizing a surface of a metallic film to be polished by moving a polishing pad in sliding contact with the metallic film surface while oxidizing the metallic film surface through an electrolytic action, wherein the electropolishing liquid contains at least polishing abrasive grains and an electrolyte for maintaining the electrostatically charged state of the polishing abrasive grains.

The electropolishing liquid constituted as above uses the electrolyte for maintaining an electrostatically charged state of the polishing abrasive grains, as an electrolyte for imparting electric conductivity to the electropolishing liquid. Therefore, while a high electric conductivity of the electropolishing liquid is maintained, the electrostatically charged state of the polishing abrasive grains is not neutralized, and the polishing abrasive grains repel each other, so that coagulation or precipitation of the polishing abrasive grains would not be generated.

In addition, according to the present invention, there is provided an electropolishing method for planarizing a surface of a metallic film to be polished by moving a polishing pad in sliding contact with the metallic film surface while oxidizing the metallic film surface through an electrolytic action, wherein the electropolishing liquid contains at least polishing abrasive grains and an electrolyte for maintaining an electrostatically charged state of the polishing abrasive grains.

In the electropolishing method constituted as above, the electropolishing liquid having a high electric conductivity as above-mentioned is used, so that it is possible to obtain a high electrolyzing current and to enlarge the distance between electrodes. Besides, in the electropolishing method according to the present invention, the electropolishing liquid having a good dispersion state of the polishing abrasive grains is used, so that remaining of the abrasive grains or defects such as scratches are not generated upon polishing.

Besides, according to the present invention, there is provided a method of fabricating a semiconductor device, comprising the steps of forming a wiring groove for forming a metallic wiring in an insulating film formed on a substrate, forming a metallic film on the insulating film so as to fill up the wiring groove, and planarizing the surface of the metallic film formed on the insulating film by moving a polishing pad in sliding contact with the metallic film surface while oxidizing the metallic film surface through an electrolytic action in an electropolishing liquid, wherein the electropolishing liquid contains at least polishing abrasive grains and an eletrolyte for maintaining an electrostatically charged state of the polishing abrasive grains.

In the method of fabricating a semiconductor device constituted as above, the electropolishing method using the electropolishing liquid having a high electric conductivity and a good dispersion state of the polishing abrasive grains as above-mentioned is carried out in planarizing the surface of a wiring. Therefore, the surface of the wiring is planarized to a high degree without generating defects or the like upon polishing.

### BRIEF DESCRIPTION OF DRAWINGS

FIG. 1 is a characteristic diagram showing pH dependences of the zeta potential and the dispersion state of alumina abrasive grains.

FIG. 2 is a schematic diagram showing an electropolishing apparatus to which the present invention has been applied.

FIG. 3 is a plan view for illustrating the sliding contact condition between a polishing pad in the electropolishing apparatus and a wafer.

FIG. 4 is a sectional view taken along line A-A in FIG. 3.

FIG. 5 is an enlarged sectional view of circle B in FIG. 4.

FIG. 6 is an enlarged plan view of circle C in FIG. 3.

FIGS. 7A to 7G illustrate a method of fabricating a semiconductor device to which the present invention has been applied, in which FIG. 7A is a sectional view showing a step of forming an inter-layer insulating film, FIG. 7B is a sectional view showing a step of forming a dual Damascene structure, FIG. 7C is a sectional view showing a step of forming a barrier metal film, FIG. 7D is a sectional view showing a step of forming a seed film, FIG. 7E is a sectional view showing a step of filling up with Cu, FIG. 7F is a sectional view showing an electropolishing step, and FIG. 7G is a sectional view showing a step of forming a cap film.

### BEST MODE FOR CARRYING OUT THE INVENTION

Now, an electropolishing liquid, an electropolishing method, and a method of fabricating a semiconductor device to which the present invention has been applied will be described in detail below, referring to the drawings.

The electropolishing liquid according to the present invention is an electropolishing liquid for use in an electropolishing method for planarizing the surface of a metallic film to be polished by moving a polishing pad in sliding contact with the surface of the metallic film while oxidizing the surface of the metallic film through an electrolytic action. Incidentally, in the following description, the case where the metallic film is a Cu film will be taken as an example for description.

The electropolishing liquid comprises a slurry for use in CMP as a base, and contains polishing abrasive grains containing alumina (Al₂O₃) for enhancing planarizing capability (hereinafter referred to as alumina abrasive grains), various additives such as an abrasive grain dispersant, an oxidizing agent, a complexing agent, an anticorrosive, and a lustering agent, etc. Furthermore, the electropolishing liquid according to the present invention contains an electrolyte for enhancing the electric conductivity required for passing an electrolyzing current.

The alumina abrasive grains are pressed against and brought into sliding contact with a Cu film by a polishing pad disposed opposite to the Cu film, to mechanically grind off and remove projected portions of the surface of the Cu film denatured through oxidation, complex formation and the like under an electrolytic action. The alumina abrasive grains has a primary grain diameter of about 0.05 μm and a secondary grain diameter of about 0.1 to 0.3 μm.

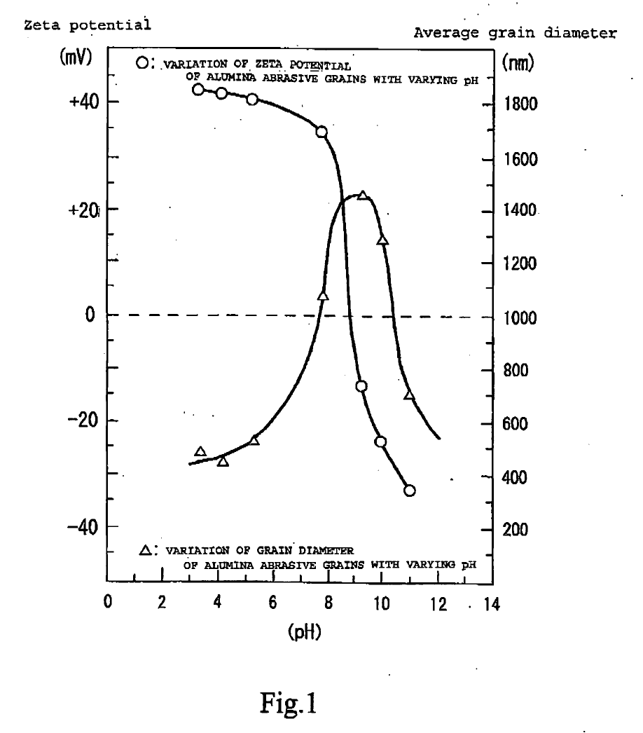

Here, pH dependencies of the zeta potential and the variation of average grain diameter, or dispersion state, of the alumina abrasive grains will be described referring to FIG. 1. The alumina abrasive grains in the electropolishing liquid has a zeta potential varying largely depending on the pH of the electropolishing liquid, and, particularly, has near pH 9 an isoelectric point where the zeta potential is zero. At the isoelectric point, the electrostatic repelling forces between the alumina abrasive grains disappear, so that coagulation of the alumina abrasive grains is conspicuous. In addition, the dispersing effect of a surface active agent also varies largely depending on the pH. Accordingly, in order to stabilize the dispersion state of the alumina abrasive grains in the electropolishing liquid, it is necessary to control the pH to within an appropriate range. Specifically, it is necessary to maintain the electropolishing liquid in an acidic region or a neutral region, particularly in the range of pH 3.0 to pH 3.5.

The electrolyte added to the electropolishing liquid is required to display a sufficient electric conductivity in an acidic region where the alumina abrasive grains are dispersed favorably, specifically in the range of pH 3.0 to pH 3.5. Therefore, direct use of alkali metals such as sodium and potassium as the electrolyte is unsuitable, since the alkali metals shift the pH of the electropolishing liquid to the basic side.

In the electropolishing liquid according to the present invention, the above-mentioned alumina abrasive grains are contained in combination with a specified electrolyte which does not largely vary the pH where the alumina abrasive grains show a high zeta potential. This ensures that the electric conductivity of the electropolishing liquid is enhanced, and the electrostatically charged state of the alumina abrasive grains in plus polarity is maintained, so that the alumina abrasive grains repel each other, and coagulation or precipitation of the alumina abrasive grain is restrained. Therefore, when this electropolishing liquid is applied to an electropolishing method and a method of fabricating a semiconductor device which will be described later, planarization of a metallic film is realized without causing such defects as scratches due to coagulation or precipitation of the alumina abrasive grains.

Besides, the electrolyte contained in the electropolishing liquid is required to have various properties, other than the above-mentioned property relating to the large variation of the pH of the electroolishing liquid. For example, the electrolyte is required not to have an oxidizing ability. The reason is as follows. When an acid having a strong oxidizing ability, such as nitric acid and hydrochloric acid, or an electrolyte having an oxidizing ability, such as iodine, is added to the electropolishing liquid, there is the possibility that the electrolyte having the oxidizing ability would oxidize the surface of the Cu film, and the resulting Cu oxide would react with the complexing agent in the electropolishing liquid to form a complex, with the result of dissolution of Cu.

In addition, the electrolyte is required not to act directly on the Cu film, namely, not to have a dissolving action on the Cu film. The reason is as follows. When sulfate ion, ammonium ion, chloride ion or the like is added, for example in the form of ammonium sulfate or the like, to the electropolishing liquid, it may react with the Cu film to form a water-soluble complex, thereby dissolving Cu, or it may directly dissolve the Cu film, thereby dissolving Cu.

Furthermore, the electrolyte is required not to have corrosiveness or specific adsorption property for the Cu film. The reason is as follows. When propionic acid, chloride ion or the like which has corrosiveness or specific adsorption property for the Cu film is added to the electropolishing liquid, defects such as corrosion, roughening and pit formation are generated in the Cu film surface at the end point of polishing, whereby the planarness of the Cu film surface is spoiled.

The electropolishing liquid according to the present invention, in which the electrolyte satisfying the above-mentioned conditions is used, is free of adverse effects on the Cu film, such as oxidation of the Cu film, direct action on the Cu film to dissolve Cu, corrosion of the Cu film, etc. Therefore, when the electropolishing liquid is used in the electropolishing method as described later, it is possible to realize better planarness and formation of a good wiring.

The electrolytes satisfying the above-mentioned conditions are generally classified into acids not having an oxidizing ability, neutral salts not having an oxidizing ability, neutral metallic salts not having an oxidizing ability, Cu ion and the like.

Examples of the acids not having an oxidizing ability include phosphoric acid. Examples of the neutral salts not having an oxidizing ability include sodium sulfate and potassium sulfate. Examples of the neutral metallic salts not having an oxidizing ability include aluminum sulfate, aluminum phosphate, cobalt sulfate, and nickel sulfate. The Cu ion may be produced by adding copper oxide (CuO), copper sulfate anhydride, copper phosphate or the like to the electropolishing liquid, or may be produced by electrolytically dissolving Cu in the electropolishing liquid through passing an electric current to the Cu film to be polished. Among these electrolytes, phosphoric acid is particularly preferable for use.

The addition amounts of these electrolytes have respective optimum ranges. For example, where phosphoric acid is used as the electrolyte, it is preferable to add phosphoric acid in an amount of about 4 to 8 g per 100 g of the electropolishing liquid before the addition. When the addition amount of phosphoric acid is set within this range, it is possible to set the electropolishing liquid in the range of pH 3.0 to pH 3.5, without inducing large variation of pH, and to obtain electric conductivity necessary for electropolishing. Where sodium sulfate is used as the electrolyte, it is preferable to add sodium sulfate in an amount of about 2 to 4 g per 100 g of the electropolishing liquid before the addition. When the addition amount of sodium sulfate is set within this range, it is possible to obtain electric conductivity necessary for electropolishing, without inducing large variation of pH. The expression “electric conductivity necessary for electropolishing” used herein means an electric conductivity such that the current density is not less than about 10 to 30 mA/cm² when the electropolishing liquid is used and a voltage of 2 V is impressed between electrodes disposed with a spacing therebetween of 20 mm.

Next, the composition of the electropolishing liquid, other than the above-described alumina abrasive grains and electrolyte, will be described.

The surface active agent is a component added for the purpose of stabilizing the dispersion state in the electropolishing liquid, of the alumina abrasive grains which are intrinsically insoluble in water. Specifically, a micellar structure is formed for each of individual alumina abrasive grains by use of the surface active agent, to cause hydration, whereby the dispersion of the alumina abrasive grains in the electropolishing liquid is stabilized, and coagulation or precipitation of the alumina abrasive grains is prevented.

Typical examples of the surface active agent include anionic surface active agents, nonionic surface active agents, cationic surface active agents, and amphoteric surface active agents. In order to contrive enhancement of the dispersion of the alumina abrasive grains which are electrostatically charged in plus polarity, particularly, it is preferable to use an anionic surface active agent or a nonionic surface active agent.

Specific examples of the anionic surface active agent include: fatty acid salts such as sodium fatty acid salts and potassium fatty acid salts; alkylsulfuric ester such as sodium alkylsulfate; alkylbenzenesulfonates such as sodium alkylbenzenesulfonates; alkylnaphthalenesulfonates; polyoxyethylene alkylphosphates; polyoxyethylene alkylsulfuric ester; and polyoxyethylene alkyl ether acetate.

Specific examples of the nonionic surface active agent include: polyoxyethylene alkyl ethers; polyoxyalkylene alkyl ethers; sorbitan fatty acid esters; glycerin fatty acid esters; polyoxyethylene fatty acid esters; and polyoxyethylene glyceride.

The oxidizing agent is for oxidizing the surface of the Cu film to form Cu oxide so that the complexing agent can produce a chelate. Specific examples of the oxidizing agent include H₂O₂. In this case, the concentration of H₂O₂ is set to be about 5% by volume. Specifically, where a 30% H₂O₂ solution is used, the 30% H₂O₂ solution is added to the electropolishing liquid in an amount of about 15% by volume.

The complexing agent reacts with the Cu oxide formed at the surface of the Cu film by the above-mentioned oxidizing agent, to form a brittle insoluble chelate. Specific examples of the complexing agent include quinaidinic acid and anthranilic acid, and the concentration thereof is preferably about 1% by weight.

In addition to the above-described components, various additives such as an anticorrosive and a lustering agent may be added to the electropolishing liquid.

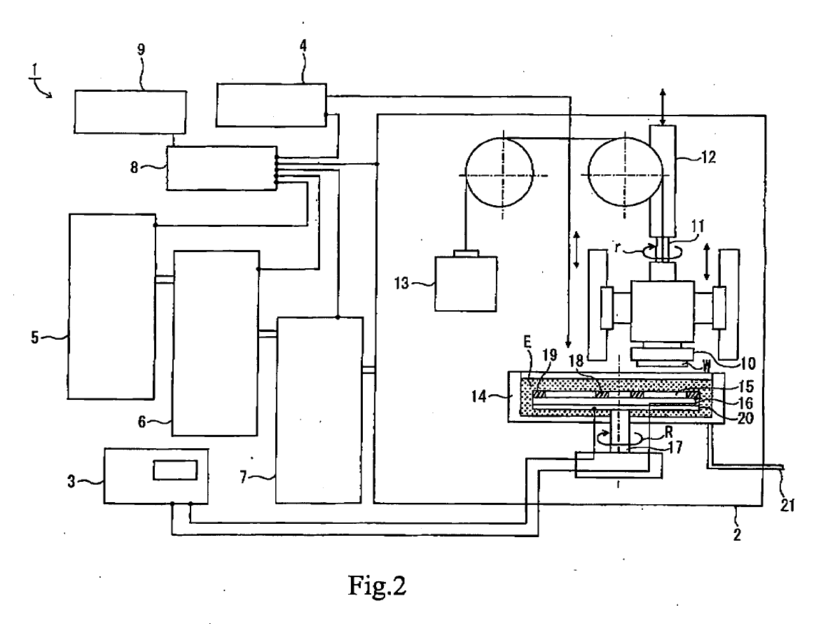

The electropolishing liquid having the above-described composition is used in an electropolishing method using an electropolishing apparatus 1 as shown in FIG. 2. The electropolishing apparatus 1 is an apparatus for planarizing a Cu film, which is formed on a wafer as a body to be finished and which acts as an anode at the time of passing an electric current, by an electrolytic action and mechanical polishing. Incidentally, the electropolishing method according to the present invention is not limited to the electropolishing method using the electropolishing apparatus which will be described below but is applicable to a variety of electropolishing methods.

The electropolishing apparatus 1 according to the present invention comprises an apparatus main body 2 for polishing a wafer W, a power source 3 for supplying a predetermined electrolyzing current to the apparatus main body 2, an electropolishing liquid tank 4 for supplying an electropolishing liquid to an electrolytic cell in the apparatus main body 2, a wafer introducing/discharging unit 5 for introducing the wafer W into the electropolishing apparatus 1, a wafer washing unit 6 for washing the wafer W fed from the wafer introducing/discharging unit 5, a wafer conveying unit 7 for conveying the wafer W to the apparatus main body 2 and for attaching and detaching the wafer W, a control unit 8 for controlling the apparatus main body 2, the electropolishing liquid tank 4, the wafer introducing/discharging unit 5, the wafer washing unit 6 and the wafer conveying unit 7, and an operating unit 9 for operating the control unit 8.

Of the above components, the apparatus main body 2 comprises a wafer chuck 10 for chucking the wafer W with the side of the Cu film directed down, a wafer rotary shaft 11 for rotating the wafer chuck 10 in the direction of arrow r at a predetermined rotational speed, and a wafer pressing means 12 for guiding the wafer chuck 10 in the vertical direction, i.e., in the Z-axis direction and for pressing the wafer chuck 10 downward with a predetermined pressure. The wafer pressing means 12 comprises a counterweight 13 so as to cancel the weights of the wafer chuck 10, the wafer rotary shaft 11 and the like, and under this condition, the processing pressure can be set in the units of 0.1 PSI (about 7 g/cm²).

In addition, the apparatus main body 2 comprises an electrolytic cell 14 for reserving a predetermined amount of the electropolishing liquid E according to the present invention, at a position opposite to the wafer chuck 10. A flat annular polishing pad 15 brought into sliding contact with the surface of the wafer W is disposed in the electrolytic cell 14, in the state of being immersed in the electropolishing liquid E. The polishing pad 15 is adhered to a surface plate 16, and, in this condition, it is rotated in the direction of arrow R at a predetermined speed by a pad rotary shaft 17 supporting the surface plate 16. The polishing pad 15 is formed, for example, of foamed polyurethane, foamed polypropylene, polyvinyl acetal or the like, has a hardness (Young's modulus) of 0.02 to 0.10 GPa, and is provided with slurry supply holes bored in the thickness direction for interposing the electropolishing liquid E. In addition, anode current-passing rings 18 and 19 for making sliding contact with edge portions of the wafer W described later and for passing an electric current with the wafer w as an anode are disposed respectively at the inner circumferential edge and the outer circumferential edge of the polishing pad 15 on the surface plate 16. Examples of the electrode material for the anode current-passing rings 18 and 19 include graphite, carbon alloys such as sintered Cu alloys and sintered silver alloys, Pt, and Cu. On the lower side of the polishing pad 15, a cathode plate 20 is disposed to be opposed to the wafer W with the surface plate 16 therebetween. The cathode plate 20 is supplied with a cathode current through the electropolishing liquid E. The cathode plate 20 is circular disk-like in shape, and the electrode material thereof is, for example, Cu, Pt or the like. A waste liquid piping 21 is attached to the electrolytic cell 14, for discharging the used electropolishing liquid E to the exterior of the apparatus main body 2.

Referring to FIGS. 3 to 6, the method of polishing the Cu film 22 formed on the wafer W by the electropolishing apparatus 1 constituted as above will be described. First, the wafer W fed in from the wafer conveying unit 7 is chucked face down by the wafer chuck 10.

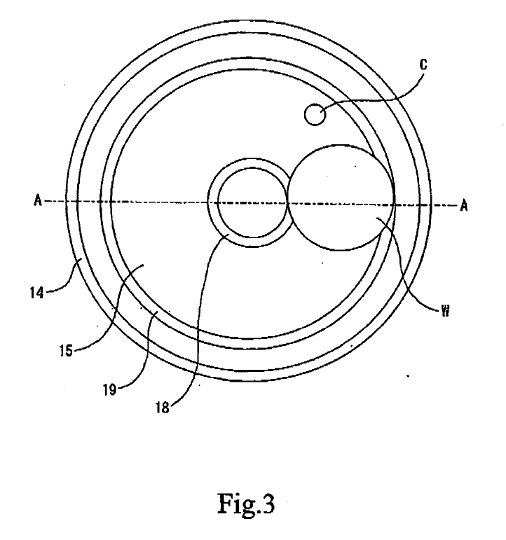

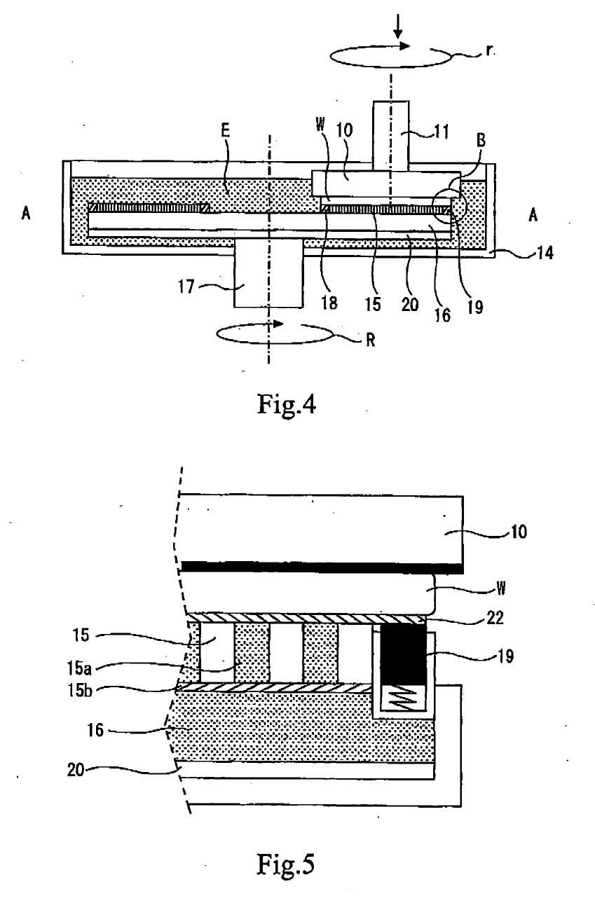

Next, as shown in FIGS. 3 and 4, the wafer W is rotated in the direction of arrow r at a speed of 10 to 30 rpm and pressed against the polishing pad 15 at a processing pressure of 0.5 to 1.5 PSI (35 to 105 g/cm²) by the wafer rotary shaft 11 and the wafer pressing means 12. Simultaneously, the polishing pad 15 adhered to the surface plate 16 is rotated in the direction of arrow R at a speed of 60 to 120 rpm by the pad rotary shaft 17, and is brought into sliding contact with the surface of the wafer W through the electropolishing liquid E.

In this instance, as shown in FIGS. 3 and 5, a part of the anode current-passing ring 18 disposed at the inner circumference of the polishing pad 15 and a part of the cathode current-passing ring 19 disposed at the outer circumference of the polishing pad 15 are normally set in sliding contact with a part of an outer circumferential portion of the Cu film 22 formed on the wafer W. In addition, as shown in FIGS. 5 and 6, the polishing pad 15 is provided with the slurry supply holes 15a penetrating therethrough in the film thickness direction, and the electropolishing liquid E is interposed from the wafer W surface (Cu film 22) through a pad support net 15b and the surface plate 16 to the cathode plate 20.

Therefore, when a voltage of 1 to 3V, for example, is impressed from the power source 3, an anode current is passed to the Cu film 22 through the anode current-passing rings 18 and 19, and an electrolyzing current (current density: 10 to 50 mA/cm²) necessary for electropolishing flows through the polishing pad 15 opposed to the Cu film 22 and through the slurry supply holes 15a to the cathode plate 20. Then, the surface of the Cu film 22 undergoing the electrolytic action as an anode undergoes anodic oxidation, with the result of formation of a Cu oxide film at the surface layer. The Cu oxide reacts with the complexing agent contained in the electropolishing liquid E to form a Cu complex, and due to the Cu complex, a denatured layer such as a high electric resistance film, an insoluble complex film, and a passivation film is formed on the surface of the Cu film 22.

Simultaneously with the anodic oxidation of the Cu film 22 under the electrolytic action, wiping is conducted as above-mentioned. Specifically, the polishing pad 15 is pressed against and brought into sliding contact with the surface of the Cu film 22, whereby the denatured layer present at the surface layer of projected portions of the Cu film 22 having the projected portions and recessed portions is mechanically removed, to expose the underlying Cu. On the other hand, the denatured layer at the recessed portions is left unremoved. Further, the portions where Cu is exposed after the removal of the denatured layer at the projected portions is again subjected to the electrolytic action. Such a cycle of electropolishing and wiping is repeated, whereby planarization of the Cu film 22 formed on the wafer w is made to proceed.

According to the present invention, use is made of the electropolishing liquid which contains the above-mentioned alumina abrasive grains in combination with the specified electrolyte such as not to largely vary the pH at which the alumina abrasive grains show a high zeta potential. Therefore, planarization of the Cu film can be realized, without generating defects such as scratches which might arise from the coagulation or precipitation of the alumina abrasive grains. In addition, according to the present invention, the electropolishing liquid showing a high electric conductivity is used, so that it is possible to enhance the electrolyzing current at the same impressed voltage as compared with the case of using, for example, an ordinary CMP slurry as the electropolishing liquid. Besides, for the same reason, the distance between the electrodes can be enlarged; therefore, uniformity of the electrolytic action becomes better, and a uniform denatured layer can be formed as a surface layer of the Cu film. As a result, the planarness of the Cu film can be further enhanced. Furthermore, according to the present invention, the removal of the Cu film can be efficiently performed at a low contact pressure. Specifically, a high polishing rate of as high as 5000 Å/min can be realized at a processing pressure of the polishing pad 15 of 1 PSI (70 g/cm²).

Incidentally, examples of the current passing sequence in carrying out the electropolishing method include the following four current passing sequences, which are not limitative.

(1) Simultaneous Electrolysis: A method in which the current passing operation for causing an electrolytic action and the mechanical polishing operation by use of the polishing pad are conducted simultaneously.

(2) Sequential Current: A method in which the current passage is turned ON and OFF during the mechanical polishing operation by use of the polishing pad. In this method, the impression of the current is intermittently conducted while the sliding contact operation of the polishing pad is continued, whereby the growth of defects such as roughening and minute pit formation in the surface of the Cu film under the electrolytic action is restrained, and a non-current-passing time necessary for the recovery of the surface under the polishing action by the polishing pad is provided. For example, a non-current-passing time of about 1 second to several tens of seconds is set, whereby perfect recover from a defective electrolyzed surface to a defect-free polished surface can be achieved by the polishing action.

(3) Perfectly Separated Sequence: A method in which only the current-passing operation is conducted in the condition where the polishing pad is out of contact with the Cu film after completion of the polishing operation by the polishing pad in the condition of not passing the current, and a method in which this operation sequence is repeated. Thus, the polishing pad does not make contact with the surface of the Cu film during the electrolytic action when the surface layer becomes unstable, and, therefore, it is possible to restrain the generation of surface defects.

(4) Simultaneous Pulse: A modification of the sequential current described in (2) above. In this method, for example, a DC current or a rectangular DC pulse current with ON/OFF times=(10 to 100 ms)/(10 to 1000 ms) is impressed, whereby the time for recovery from the electrolyzed surface is set electrically.

The above-described electropolishing method is applicable to a polishing step for removing the surplus metal of a metallic film, formed for filling up wiring grooves (trenches), to planarize the surface of the metallic film and form a metallic wiring, in a method of fabricating a semiconductor device such as an LSI. Now, the method of fabricating a semiconductor device in which the above-described electropolishing method is used will be described below. The method of fabricating a semiconductor device is a method in which a metallic wiring consisting of Cu is formed by the so-called Damascene process. Incidentally, while the formation of a Cu wiring in a dual Damascene structure in which wiring grooves (trenches) and contact holes are simultaneously processed will be described in the following description, the method is naturally applicable also to the formation of a Cu wiring in a single Damascene structure in which only the wiring grooves (trenches) or only the connection holes (vias) are formed.

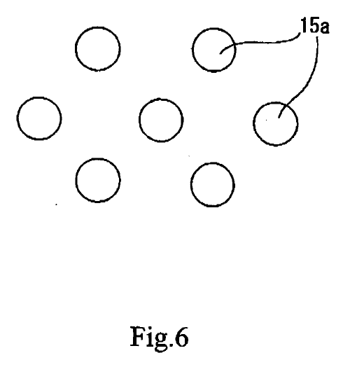

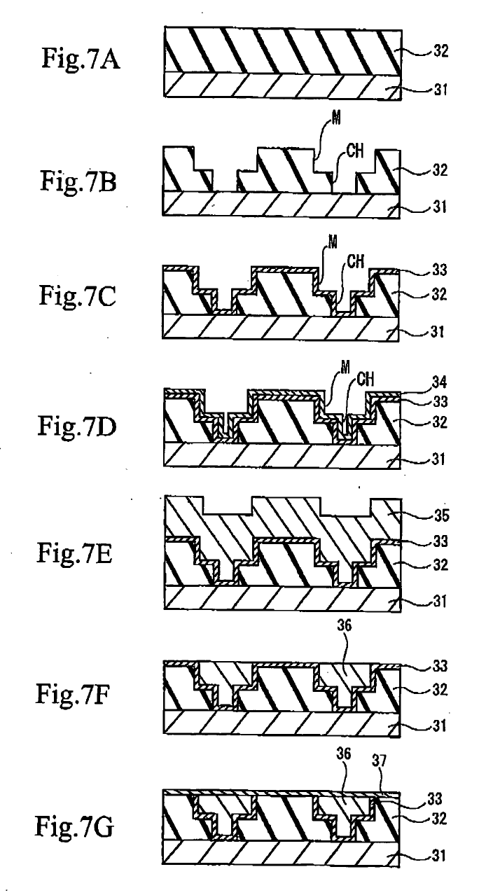

First, as shown in FIG. 7A, an inter-layer insulating film 32 formed of a low dielectric constant material such as porous silica is formed on a wafer substrate 31 formed of silicon or the like and preliminarily provided with devices (not shown) such as transistors. The inter-layer insulating film 32 is formed, for example, by vacuum CvD (Chemical Vapor Deposition) or the like.

Next, as shown in FIG. 7B, contact holes CH communicated to impurity diffusion regions (not shown) of the wafer substrate 31 and trenches M are formed, for example, by known photolithography technique and etching technique.

Subsequently, as shown in FIG. 7C, a barrier metal film 33 is formed on the inter-layer insulating film 32 and in the contact holes CH and the trenches M. The barrier metal film 33 is formed, for example, from a material such as Ta, Ti, W, Co, TaN, TiN, WN, CoW, and COWP, by PVD (Physical Vapor Deposition) using a sputtering apparatus, a vacuum vapor deposition apparatus or the like. The barrier metal film 33 is formed for the purpose of preventing diffusion of Cu into the inter-layer insulating film 32.

After the formation of the barrier metal film 33 as above, the trenches M and the contact holes CH are filled up with Cu. The filling-up with Cu can be conducted by any of various known techniques used conventionally, for example, an electroplating method, a CVD method, a sputtering and reflow method, a high-pressure reflow method, electroless plating or the like. Incidentally, the filling-up with Cu is preferably conducted by the electroplating method, from the viewpoints of film formation speed, film formation cost, the purity of the metallic material to be formed, adhesion property and the like. In carrying out the filling-up with Cu by the electroplating method, as shown in FIG. 7D, a seed film 34 consisting of the same material as the wiring forming material, i.e., Cu is formed on the barrier metal film 33 by sputtering or the like. The seed film 34 is formed for promoting the Cu grain growth when the trenches M and the contact holes CH are filled up with Cu.

The filling-up of the trenches M and the contact holes CH with Cu is conducted by any of the above-mentioned various methods in which, as shown in FIG. 7E, a Cu film 35 is formed on the whole part of the inter-layer insulating film 32 inclusive of the inside of the trenches M and the contact holes CH. The Cu film 35 has a film thickness not less than the depths of the trenches M and the contact holes CH, and is formed on the inter-layer insulating film 32 having steps of the trenches M and the contact holes CH, so that the Cu film 35 also has steps corresponding to the pattern of the steps of the inter-layer insulating film 32. Incidentally, where the filling-up with Cu is carried out by the electroplating method, the seed film 34 formed on the barrier metal film 33 is united with the Cu film 35.

Then, the wafer substrate 31 provided thereon with the Cu film 35 is subjected to a polishing step. In the polishing step, the above-mentioned electropolishing method is carried out in which electropolishing by use of the electropolishing liquid and wiping by use of the polishing pad are simultaneously performed. Specifically, an electric current is passed with the Cu film 35 as an anode, the Cu film 35 is opposed to a cathode plate in the electropolishing liquid, and an electrolyzing current is passed to perform electropolishing. Simultaneously, a denatured layer formed at the surface of the Cu film 35 under the electropolishing action is subjected to wiping by a method in which a polishing pad is pressed against and brought into sliding contact with the denatured layer at a pressure of not more than the breaking pressure of the extremely low dielectric constant material such as porous silica, for example, about 1.5 PSI (105 g/cm²), whereby the denatured layer at projected portions of the Cu film 35 is removed. In the wiping by use of the polishing pad, only the denatured layer at the projected portions of the Cu film 35, whereas the denatured layer at recessed portions of the Cu film 35 is left as it is. Then, electropolishing is made to proceed, whereby the base Cu film 35 is subjected further to anodic oxidation. In this case, since the denatured layer is remaining at the recessed portions of the Cu film 35, the electropolishing does not proceed there, with the result that only the projected portions of the Cu film 35 are polished. Thus, the formation of the denatured layer by electropolishing and the removal of the denatured layer by wiping are repeated, whereby, as shown in FIG. 7F, the Cu film 35 is planarized, and Cu wirings 36 are formed in the trenches M and the contact holes CH.

After the above-described polishing step, the semiconductor device is subjected to polishing and washing of the barrier metal film 33, whereby, as shown in FIG. 7G, a cap film 37 is formed on the wafer substrate 31 provided with the Cu wirings 36. Then, the steps from the formation of the inter-layer insulating film 32 (shown in FIG. 7A) to the formation of the cap film 37 are repeated, to obtain a multilayer structure.

Thus, the electropolishing method using the electropolishing liquid as above-described is carried out in the process of fabricating a semiconductor device, which ensures that the remaining of the alumina abrasive grains and defects such as scratches due to coagulation or precipitation of the abrasive grains are absent, so that the semiconductor device obtained is free of such defects as short-circuit between the wirings and open-circuit. In addition, since the wirings are polished by use of the electropolishing liquid having a high electric conductivity, the distance between the electrodes can be enlarged, the electric current can be stably passed with a uniform current density distribution, generation of such troubles as pit formation due to concentration of the current can be obviated, the wirings with good surface roughness can be obtained, and Cu wirings with stable electric resistance can be obtained.

Besides, since the above-described electropolishing liquid is used, generation of such defects as roughening due to corrosion is obviated, and Cu is not dissolved. Therefore, it is possible to restrain the rise in the elusion rate of fine Cu wirings 36, and to obviate the generation of such defects as disappearance of wirings and insufficient wiring sectional areas.

Furthermore, in the electropolishing method using the electropolishing liquid as above-described, the material constituting the surface not to be polished is not required to have a high mechanical strength; therefore, the electropolishing method can be applied to the process of fabricating a semiconductor device in which a brittle extremely low dielectric constant material is used. Therefore, according to the present invention, it is possible to adopt an extremely low dielectric constant material as an insulating material in a semiconductor device, which contributes to further enhancement of speed and further lowering of power consumption, of LSIs in the future.

The present invention is not limited to the above description, and, if required, various modifications are possible without departure from the gist of the invention

### INDUSTRIAL APPLICABILITY

As is clear from the above description, according to the present invention, by combining specified polishing abrasive grains with a specified electrolyte, it is possible to provide an electropolishing liquid capable of having both a high electric conductivity and a stable dispersion state of the polishing abrasive grains.

In addition, according to the present invention, by use of the electropolishing liquid having both a high electric conductivity and a good dispersion state of polishing abrasive grains as above-mentioned, it is possible to provide an electropolishing method capable of a high degree of planarization of a metallic film.

Besides, according to the present invention, the electropolishing method is carried out by use of the above-described electropolishing liquid having both a high electric conductivity and a good dispersion state of polishing abrasive grains in planarizing the surface of wirings, and, therefore, it is possible to provide a method of fabricating a semiconductor device by which wirings having a surface with stable electric resistance can be formed.

1. An electropolishing liquid for use in an electropolishing method for planarizing a surface of a metallic film to be polished by moving a polishing pad in sliding contact with said metallic film surface while oxidizing said metallic film surface through an electrolytic action, wherein
said electropolishing liquid contains at least polishing abrasive grains and an electrolyte for maintaining an electrically charged state of said polishing abrasive grains.

2. An electropolishing liquid as set forth in claim 1, wherein said electrolyte does not have a dissolving action on said metallic film.

3. An electropolishing liquid as set forth in claim 1, wherein said electrolyte does not have corrosiveness or specific adsorption property for said metallic film.

4. An electropolishing liquid as set forth in claim 1, wherein said electrolyte is at least one selected from the group consisting of an acid not having an oxidizing ability, a neutral salt not having an oxidizing ability, a neutral metallic salt not having an oxidizing ability, and the metallic ion constituting said metallic film.

5. An electropolishing liquid as set forth in claim 4, wherein said acid not having an oxidizing ability is phosphoric acid.

6. An electropolishing liquid as set forth in claim 4, wherein said neutral salt not having an oxidizing ability is at least one selected from the group consisting of sodium sulfate and potassium sulfate.

7. An electropolishing liquid as set forth in claim 4, wherein said neutral metallic salt not having an oxidizing ability is at least one selected from the group consisting of aluminum sulfate, aluminum phosphate, cobalt sulfate, and nickel sulfate.

8. An electropolishing liquid as set forth in claim 1, which contains an oxidizing agent for oxidizing said metallic film to form an oxide.

9. An electropolishing liquid as set forth in claim 8, which contains a complexing agent for reacting with said oxide to form an insoluble chelate.

10. An electropolishing liquid as set forth in claim 1, which contains a surface active agent.

11. An electropolishing liquid as set forth in claim 1, wherein said metallic film contains Cu.

12. An electropolishing liquid as set forth in claim 1, wherein said polishing abrasive grains contain alumina.

13. An electropolishing liquid as set forth in claim 12, which is acidic or neutral.

14. An electropolishing liquid as set forth in claim 13, which has a pH in the range of from pH 3.0 to pH 3.5.

15. An electropolishing method for planarizing a surface of a metallic film to be polished by moving a polishing pad in sliding contact with said metallic film surface while oxidizing said metallic film surface through an electrolytic action in an electropolishing liquid, wherein
said electropolishing liquid contains at least polishing abrasive grains and an electrolyte for maintaining an electrostatically charged state of said polishing abrasive grains.

16. An electropolishing method as set forth in claim 15, wherein said electrolyte does not have a dissolving action on said metallic film.

17. An electropolishing method as set forth in claim 15, wherein said electrolyte does not have corrosiveness or specific adsorption property for said metallic film.

18. An electropolishing method as set forth in claim 15, wherein said electrolyte is at least one selected from the group consisting of an acid not having an oxidizing ability, a neutral salt not having an oxidizing ability, a neutral metallic salt not having an oxidizing ability, and the metallic ion constituting said metallic film.

19. An electropolishing method as set forth in claim 18, wherein said acid not having an oxidizing ability is phosphoric acid.

20. An electropolishing method as set forth in claim 18, wherein said neutral salt not having an oxidizing ability is at least one selected from the group consisting of sodium sulfate and potassium sulfate.

21. An electropolishing method as set forth in claim 18, wherein said neutral metallic salt not having an oxidizing ability is at least one selected from the group consisting of aluminum sulfate, aluminum phosphate, cobalt sulfate, and nickel sulfate.

22. An electropolishing method as set forth in claim 15, wherein said electropolishing liquid contains an oxidizing agent for oxidizing said metallic film to form an oxide.

23. An electropolishing method as set forth in claim 22, wherein said electropolishing liquid contains a complexing agent for reacting with said oxide to form an insoluble chelate.

24. An electropolishing method as set forth in claim 15, wherein said electropolishing liquid contains a surface active agent.

25. An electropolishing method as set forth in claim 15, wherein said metallic film contains Cu.

26. An electropolishing method as set forth in claim 15, wherein said polishing abrasive grains contain alumina.

27. An electropolishing method as set forth in claim 26, wherein said electropolishing liquid is acidic or neutral.

28. An electropolishing method as set forth in claim 27, wherein said electropolishing liquid has a pH in the range of from pH 3.0 to pH 3.5.

29. A method of fabricating a semiconductor device, comprising the steps of forming a wiring groove for forming a metallic wiring in an insulating film formed on a substrate, forming a metallic film on said insulating film so as to fill up said wiring groove, and
planarizing the surface of said metallic film formed on said insulating film by moving a polishing pad in sliding contact with said metallic film surface while oxidizing said metallic film surface through an electrolytic action in an electropolishing liquid, wherein
said electropolishing liquid contains at least polishing abrasive grains and an electrolyte for maintaining an electrostatically charged state of said polishing abrasive grains.

30. A method of fabricating a semiconductor device as set forth in claim 29, wherein said electrolyte does not have a dissolving action on said metallic film.

31. A method of fabricating a semiconductor device as set forth in claim 29, wherein said electrolyte does not have corrosiveness or specific adsorption property for said metallic film.

32. A method of fabricating a semiconductor device as set forth in claim 29, wherein said electrolyte is at least one selected from the group consisting of an acid not having an oxidizing ability, a neutral salt not having an oxidizing ability, a neutral metallic salt not having an oxidizing ability, and the metallic ion constituting said metallic film.

33. A method of fabricating a semiconductor device as set forth in claim 32, wherein said acid not having an oxidizing ability is phosphoric acid.

34. A method of fabricating a semiconductor device as set forth in claim 32, wherein said neutral salt not having an oxidizing ability is at least one selected from the group consisting of sodium sulfate and potassium sulfate.

35. A method of fabricating a semiconductor device as set forth in claim 32, wherein said neutral metallic salt is at least one selected from the group consisting of aluminum sulfate, aluminum phosphate, cobalt sulfate, and nickel sulfate.

36. A method of fabricating a semiconductor device as set forth in claim 29, wherein said electropolishing liquid contains an oxidizing agent for oxidizing said metallic film to form an oxide.

37. A method of fabricating a semiconductor device as set forth in claim 36, wherein said electropolishing liquid contains a complexing agent for reacting with said oxide to form an insoluble chelate.

38. A method of fabricating a semiconductor device as set forth in claim 29, wherein said electropolishing liquid contains a surface active agent.

39. A method of fabricating a semiconductor device as set forth in claim 29, wherein said metallic film contains Cu.

40. A method of fabricating a semiconductor device as set forth in claim 29, wherein said polishing abrasive grains contain alumina.

41. A method of fabricating a semiconductor device as set forth in claim 40, wherein said electropolishing liquid is acidic or neutral.

42. A method of fabricating a semiconductor device as set forth in claim 41, wherein said electropolishing liquid has a pH in the range of from pH 3.0 to pH 3.5.

43. A method of fabricating a semiconductor device as se forth in claim 29, wherein said insulating film is formed of a low dielectric constant material.
